(19) United States
(12) Patent Application Publication
(10) Pub. No.: US 2026/0014960 A1
(43) Pub. Date: Jan. 15, 2026

(54) ACCESS CLOSURE CONTROL WITH VEHICLE-MOUNTED, MANUALLY ACTIVATED SENSOR ASSEMBLY

(71) Applicant: ADAC Plastics, Inc., Grand Rapids, MI (US)

(72) Inventors: Keith Scheiern, Lowell, MI (US); Tyler John Marvin, Caledonia, MI (US); Thomas William Allen, Gowen, MI (US); Anne Adamczyk, Grand Rapids, MI (US); Jordan Buechler, Holland, MI (US)

(21) Appl. No.: 19/331,783

(22) Filed: Sep. 17, 2025

Related U.S. Application Data
(63) Continuation-in-part of application No. 18/975,956, filed on Dec. 10, 2024.
Application No. 18/975,956 is a continuation of application No. 18/194,998, filed on Apr. 3, 2023, now Pat. No. 12,194,960.
(60) Provisional application No. 63/326,971, filed on Apr. 4, 2022.
(60) Provisional application No. 63/697,144, filed on Sep. 20, 2024.

(51) Int. Cl. B60R 25/34; B60R 13/00

(52) U.S. Cl. CPC B60R 25/34; B60R 13/005

(57) ABSTRACT

A control assembly includes a sensor module configured to mount to an access closure or to an exterior component of a motor vehicle, the sensor module including a deflectable wall and a sensor circuit including a sensor configured to produce a sensor signal, a cover mounted to the sensor module with an exterior surface of the cover exposed on the access closure or on the exterior component of the motor vehicle, and at least one protrusion extending between the cover and the deflectable wall, the at least one protrusion concentrating force, applied by manual contact with the cover, to the deflectable wall of the sensor module to cause the deflectable wall to deflect toward the sensor, and the sensor produces a detectable change in the sensor signal, for causing a corresponding change in an operating state of the access closure, in response to deflection of the deflectable wall.

### CROSS-REFERENCE TO RELATED APPLICATION

This application claims the benefit of and priority to U.S. Provisional Patent Application No. 63/697,144, filed Sep. 20, 2024, and is a continuation-in-part of U.S. patent application Ser. No. 18/975,956, filed Dec. 10, 2024, which is a continuation of U.S. patent application Ser. No. 18/194,998, filed Apr. 3, 2023, now U.S. Pat. No. 12,194,960, which claims priority to U.S. Provisional Patent Application No. 63/326,971, filed Apr. 4, 2022, the disclosures of which are all expressly incorporated herein by reference in their entireties

### FIELD OF THE INVENTION

The present invention relates generally to closure access controls for motor vehicles, and more specifically to closure access control modules including vehicle-mounted, manually activated sensor assemblies.

### BACKGROUND

Closure access control assemblies for motor vehicles are generally known. Decorative and/or informative motor vehicle badge assemblies are also generally known. It may be desirable to integrate sensor-based closure access control features into motor vehicle badge assemblies and/or into vehicle-mounted, manually actuated closure access control assemblies generally.

### SUMMARY

The present invention may comprise one or more of the features recited in the attached claims, and/or one or more of the following features and combinations thereof. In a first aspect, a closure control assembly for controlling an operating state of an access closure of a motor vehicle may comprise a sensor module configured to mount to the access closure or to an exterior component of the motor vehicle, the sensor module including a deflectable wall with opposing front and rear surfaces, at least one electrically conductive member affixed to or integral with the rear surface, and a sensor circuit including a sensor spaced apart from the at least one electrically conductive member and configured to produce a sensor signal, a cover mounted to the sensor module with an interior surface of the cover facing the front surface of the deflectable wall of the sensor module, and with an exterior surface of the cover exposed on the access closure or on the exterior component of the motor vehicle to provide for manual contact therewith, and at least one protrusion extending between the interior surface of the cover and the front surface of the deflectable wall, the at least one protrusion configured to concentrate force, applied by manual contact with the exterior surface of the cover, to the deflectable wall of the sensor module to cause the deflectable wall to deflect toward the sensor, the sensor configured to produce a detectable change in the sensor signal, for causing a corresponding change in the operating state of the access closure, in response to deflection of the deflectable wall sufficiently to move the at least one electrically conductive member to within a detection proximity of the sensor.

A second aspect includes the features of the first aspect, and wherein the at least one protrusion is affixed to or integral with the interior surface of the cover, such that the at least one protrusion extends from the interior surface of the cover toward and into contact with the front surface of the deflectable wall of the sensor module.

A third aspect includes the features of the first aspect, and wherein the at least one protrusion is affixed to or integral with the front surface of the deflectable wall of the sensor module such that the at least one protrusion extends from the front surface of the deflectable wall toward and into contact with the interior surface of the cover.

A fourth aspect includes the features of the first aspect, and wherein the at least one protrusion is centered over the at least one sensor.

A fifth aspect includes the features of the first aspect, and wherein the sensor circuit includes a plurality of sensors positioned side by side and each spaced apart from the at least one electrically conductive member and configured to produce a respective sensor signal, and the detectable change in the sensor signal comprises a detectable change in at least one of the sensor signals produced by the plurality of sensors, and wherein the at least one protrusion includes a plurality of protrusions each extending between the interior surface of the cover and the front surface of the deflectable wall, each of the plurality of protrusions centered over a respective one of the plurality of sensors.

A sixth aspect includes the features of the first aspect, and wherein the sensor module is configured to be mounted to, or integral with, the exterior component of the motor vehicle with the exterior surface of the cover exposed on the exterior component, and wherein the exterior component of the motor vehicle is adjacent to or near the access closure.

A seventh aspect includes the features of the sixth aspect, and wherein the exterior component of the motor vehicle to which the sensor module is configured to be mounted or integral with is a lamp assembly of the motor vehicle, a body panel of the motor vehicle, or a bumper of the motor vehicle.

An eighth aspect includes the features of the seventh aspect, and wherein the closure control assembly is configured to be mounted to, or integral with, the lamp assembly of the motor vehicle, and wherein the lamp assembly comprises a frame, bracket, or housing configured to be mounted to the motor vehicle, at least one light source, and a lens assembly, including at least one lens, configured to be mounted to the frame, bracket, or housing with the at least one light source positioned between the lens assembly and the frame, bracket, or housing, and wherein the closure control assembly is configured to be mounted to, or integral with, the frame, bracket, or housing such that the exterior surface of the cover of the closure control assembly is exposed along the frame, bracket, or housing, or is configured to be mounted to, or integral with, the lens assembly such that the exterior surface of the cover of the closure control assembly is exposed along the at least one lens.

A ninth aspect includes the features of the first aspect, and may further comprise at least one processing circuit configured to be responsive to the detectable change in the sensor signal to produce at least one control signal configured to cause the corresponding change in the operating state of the access closure.

A tenth aspect includes the features of the ninth aspect, and wherein the access closure of the motor vehicle is a power access closure, and wherein the closure control assembly further comprises means responsive to at least one control signal to change the operating state of the power access closure.

An eleventh aspect includes the features of the tenth aspect, and wherein the power access closure is a trunk, a frunk, a tailgate, a liftgate, or a side door of the motor vehicle.

A twelfth aspect includes the features of the tenth aspect, and wherein the closure control assembly is configured to be mounted to, or integral with, the exterior component of the motor vehicle with the exterior surface of the cover exposed on the exterior component.

A thirteenth aspect includes the features of the twelfth aspect, and wherein the exterior component of the motor vehicle to which the closure control assembly is configured to be mounted or integral with is a lamp assembly of the motor vehicle, a body panel of the motor vehicle, or a rear bumper of the motor vehicle.

In a fourteenth aspect, a system for controlling an operating state of a power tailgate of a motor vehicle comprises the closure control assembly of claim 1, wherein the access closure is the power tailgate, and at least one processing circuit configured to be responsive to the detectable change in the sensor signal to produce at least one control signal configured to cause the corresponding change in the operating state of the power tailgate, wherein the exterior component is a tail lamp assembly of the motor vehicle, and the sensor module of the closure control assembly is mounted to or proximate to the tail lamp assembly and the exterior surface of the cover is exposed on or proximate to the tail lamp assembly of the motor vehicle to provide for manual contact therewith.

A fifteenth aspect includes the features of the fourteenth aspect, and may further comprise means responsive to the at least one control signal to change the operating state of the power tailgate, and wherein the change in the operating state of the power tailgate includes a change from an open state of the power tailgate to a closed state of the power tailgate or a change from the closed state of the power tailgate to the open state of the power tailgate.

A sixteenth aspect includes the features of the fourteenth aspect, and wherein the closure control assembly is mounted to, or integral with, the tail lamp assembly.

A seventeenth aspect includes the features of the sixteenth aspect, and wherein the tail lamp assembly comprises a frame, bracket, or housing configured to be mounted to the motor vehicle, at least one light source, and a lens assembly, including at least one lens, configured to be mounted to the frame, bracket, or housing with the at least one light source positioned between the lens assembly and the frame, bracket, or housing.

An eighteenth aspect includes the features of the seventeenth aspect, and wherein the sensor module of the closure control assembly is mounted to, or integral with, the frame, bracket, or housing such that the exterior surface of the cover of the closure control assembly is exposed along the frame, bracket, or housing.

A nineteenth aspect includes the features of the seventeenth aspect, and wherein the sensor module of the closure control assembly is mounted to, or integral with, the lens assembly such that the exterior surface of the cover of the closure control assembly is exposed along the at least one lens.

A twentieth aspect includes the features of the fourteenth aspect, and wherein the sensor module of the closure control assembly is mounted to, or integral with, a body panel of the motor vehicle proximate to the tail lamp assembly such that the exterior surface of the cover of the closure control assembly is exposed along the body panel.

### BRIEF DESCRIPTION OF THE DRAWINGS

This disclosure is illustrated by way of example and not by way of limitation in the accompanying Figures. Where considered appropriate, reference labels have been repeated among the Figures to indicate corresponding or analogous elements.

FIG. 1 is a rear perspective view of a sensor-based badge assembly operatively mounted to a rear access closure of a motor vehicle.

FIG. 2 is a rear elevational view of an embodiment of the sensor-based badge assembly depicted by example in FIG. 1.

FIG. 3 is a front perspective view of an embodiment of the sensor housing of the badge assembly illustrated in FIG. 2.

FIG. 4 is a rear perspective view of the sensor housing illustrated in FIG. 3.

FIG. 5 is a front perspective view of the sensor module of the badge assembly illustrated in FIG. 2.

FIG. 6 is a rear elevational view of an embodiment of the badge of the sensor-based badge assembly illustrated in FIG. 2.

FIG. 7 is a cross-sectional view of the sensor-based badge assembly of FIG. 2, as viewed along section lines 7,11-7, 11, illustrating various components of the sensor module and of the badge.

FIG. 8 is a cross-sectional view of the sensor-based badge assembly of FIG. 2, as viewed along section lines 8,12-8, 12, illustrating additional components of the sensor module and of the badge.

FIG. 9 is a front perspective view of another embodiment of the sensor housing of the badge assembly illustrated in FIG. 2.

FIG. 10 is a front perspective view of the sensor module of the badge assembly including the housing illustrated in FIG. 9.

FIG. 11 is a cross-sectional view of the sensor-based badge assembly similar to FIG. 7, as viewed along section lines 7,11-7, 11 of FIG. 2, illustrating various components of the sensor module with the housing illustrated in FIGS. 9 and 10 and with an alternate embodiment of the badge.

FIG. 12 is a cross-sectional view of the sensor-based badge assembly similar to FIG. 8, as viewed along section lines 8,12-8, 12 of FIG. 2, illustrating additional components of the sensor module with the housing illustrated in FIGS. 9-11 and with the alternate embodiment of the badge.

FIGS. 13A and 13B are rear perspective views of an embodiment of a sensor-based closure control assembly, operatively mounted to a body panel of an embodiment of a motor vehicle adjacent to a tail lamp assembly of the motor vehicle, for manual control of an embodiment of a rear power access closure between operating states of the access closure.

FIG. 14A is a rear perspective view of another embodiment of a closure control assembly operatively mounted to the tail lamp assembly of the motor vehicle of FIGS. 13A and 13B.

FIG. 14B is a rear perspective view of yet another embodiment of a closure control assembly operatively mounted to the tail lamp assembly of the motor vehicle of FIGS. 13A and 13B.

FIG. 14C is a rear perspective view of still another embodiment of a closure control assembly operatively mounted to the tail lamp assembly of the motor vehicle of FIGS. 13A and 13B.

FIGS. 15A and 15B are rear perspective views of another embodiment of a sensor-based closure control assembly, operatively mounted to a tail lamp assembly of another embodiment of a motor vehicle, for manual control of another embodiment of a rear power access closure between operating states of the access closure.

FIG. 16 is a rear perspective view of a further embodiment of a sensor-based closure control assembly, operatively mounted to a tail lamp assembly of yet another embodiment of a motor vehicle, for manual control of yet another embodiment of a rear power access closure between operating states of the access closure.

FIG. 17 is a simplified block diagram schematic of a control system for controlling operation of a power access closure of a motor vehicle between operating states thereof based on sensor signals produced by a sensor-based closure control assembly.

### DETAILED DESCRIPTION OF THE DRAWINGS

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

This disclosure relates to a sensor-based assembly for a motor vehicle including a motor vehicle badge or cover operatively coupled to a sensor module such that the sensor module is responsive to manual force applied to a display surface of the badge, or to an exposed, exterior surface of the cover, to cause a change in an operating state of an access closure of the motor vehicle. As used herein, the term “badge” or “motor vehicle badge” shall be understood to mean an informational plate or assembly having a display surface bearing information of any type, without restriction, and a mounting surface, opposite the display surface, wherein the badge assembly is to be mounted to a component of the motor vehicle in any of a number of different locations, without limitation, but generally on or near an access closure to be controlled between operational states thereof. In any case, examples of such motor vehicle badges may include, but are not limited to, one having a display surface bearing an emblem, e.g., in the form of a name, logo and/or other information relating to and/or characteristic, of the company which produced the motor vehicle to which the badge is to be attached, one having a display surface bearing information relating to a model, type or function/capability of the motor vehicle to which the badge is to be attached, e.g., “Mustang,” “Hybrid,” “4×4,” or the like, one having a display surface bearing other information relating to the owner and/or operator of the motor vehicle to which the badge is to be attached, e.g., “Sheriff,” Physician/Medical Doctor, Government Official, etc., or the like.

The term “cover,” as used herein, shall be understood to be a plate or assembly, similar or otherwise identical to a “badge,” except that the “display” surface of the badge corresponds to an exterior surface of the cover that is to be exposed on the motor vehicle, the “mounting” surface of the badge corresponds to an interior surface of the cover that is to be mounted to the sensor module, and the exterior surface of the cover may or may not bear any information of the type described above with respect to the badge, and in this regard a “badge” may be considered to be a subset of a “cover.” In embodiments in which the exterior surface of the cover does not bear information of the type described above with respect to the badge, the exterior surface of the cover may instead be generic, i.e., non-descript, or may bear some other type of marking or indicia, i.e., other than information of the type described above with respect to the badge. As one non-limiting example of the latter, the exterior surface of the cover may bear marking(s) and/or other indicia identifying the exterior surface as a surface which may be manually pressed in order to effectuate a change of state of a respective access closure of the motor vehicle.

As further used herein, the term “access closure,” shall be understood to mean any openable closure device of any type configured to cover, e.g., in a closed position, or to provide access to, e.g., in an open position, any access opening of a motor vehicle. Example motor vehicle access closures may include, but are not limited to, a hinged side door, a sliding side door, a liftgate, a tailgate, a trunk lid or door, a lid or door covering a storage or other compartment at the front of a motor vehicle, e.g., so-called “frunk,” or the like.

As further used herein, the term “state of the access closure” shall be understood to mean the operational state of the access closure, examples of which may include, but are not limited to, one or any combination of a closed state (i.e., a state in which the access closure forms a barrier over or otherwise covers or blocks a respective access opening to the motor vehicle), an open state (i.e., a state in which the access closure allows for access to the motor vehicle via the respective access opening), a latched state (i.e., a state in which the access closure is mechanically or electromechanically held in the closed state), an unlatched state (i.e., a state in which the access closure is mechanically or electromechanically released from the latched state), a locked state (i.e., a state in which the access closure is mechanically or electromechanically prevented from opening), and an unlocked state (i.e., a state in which the access closure is mechanically or electromechanically released from the locked state so as to allow the access closure to be opened). It follows that a change in an operating state of the access closure shall be understood to mean a change of the access closure from one operational state to another operational state, examples of which may include, but are not limited to, an unlocked state to a locked state, a locked state to an unlocked state, a latched state to an unlatched state, an unlatched state to a latched state, a closed state to an open state, or an open state to a closed state.

It will be understood that in some embodiments, the access closure itself may be manually actuatable between open and closed states (referred to herein as a “manually opening and closing access closure”), whereas in other embodiments the access closure may be operatively coupled to one or more motors and/or biasing structures configured to control transition(s) of the access closure from the closed state to the open state and/or vice versa (referred to herein as a “power access closure”). In the former case, as one non-limiting example, a conventional side door, liftgate, tailgate, trunk or frunk door, or the like, may be manually opened and manually closed. In the latter case, as another non-limiting example, a powered liftgate, a powered tailgate, a powered sliding door and/or a powered trunk (or frunk) lid may be opened and/or closed under the control of at least one motor and/or biasing structure. In some such embodiments, the at least one motor and/or biasing structure may be configured, in addition to controlling opening of the access closure, to unlock and/or unlatch the access closure, and/or the at least one motor and/or biasing structure may be configured, in addition to controlling closing of the access closure, to latch and/or lock the access closure. In other such embodiments, the access closure may be manually latched/unlatched, and/or manually locked/unlocked.

In some embodiments, the access closure may be manually actuatable between latched and unlatched states (referred to herein as a “manually latching/unlatching access closure”), whereas in other embodiments the access closure may be operatively coupled to an electromechanical latch module, e.g., a conventional, so-called “E-latch module,” configured to control transition(s) of the access closure from the latched state to the unlatched state and/or vice versa (referred to herein as an “E-latch access closure.”) In some such embodiments, the access closure may be a manually opening and closing access closure, and in other such embodiments the access closure may be a power access closure, and/or the access closure may be manually locked/unlocked or electromechanically locked/unlocked.

In some embodiments, the access closure may be manually actuatable between locked and unlocked states (referred to herein as a “manually locking/unlocking access closure”), whereas in other embodiments the access closure may be operatively coupled to an electromechanical lock module configured to electromechanically control transition(s) of the access closure from the locked state to the unlocked state and/or vice versa (referred to herein as an “E-lock access closure.”) In some such embodiments, the access closure may be a manually opening and closing access closure, and in other such embodiments the access closure may be a power access closure, and/or the access closure may be a manually latching/unlatching access closure or an E-latch access closure.

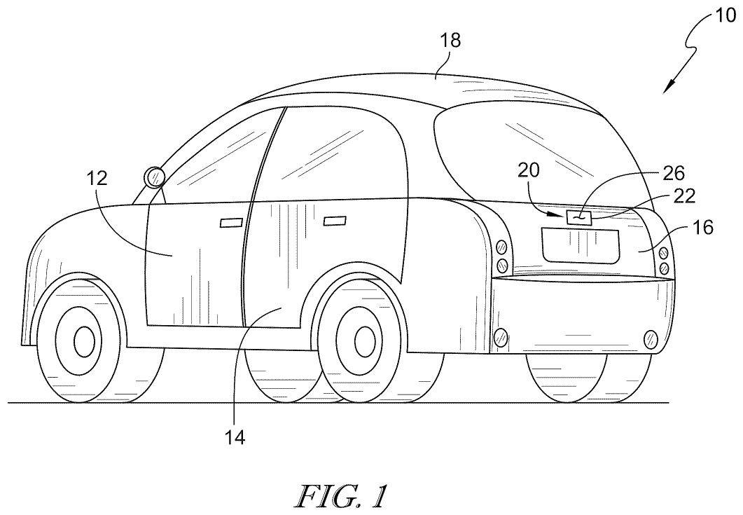

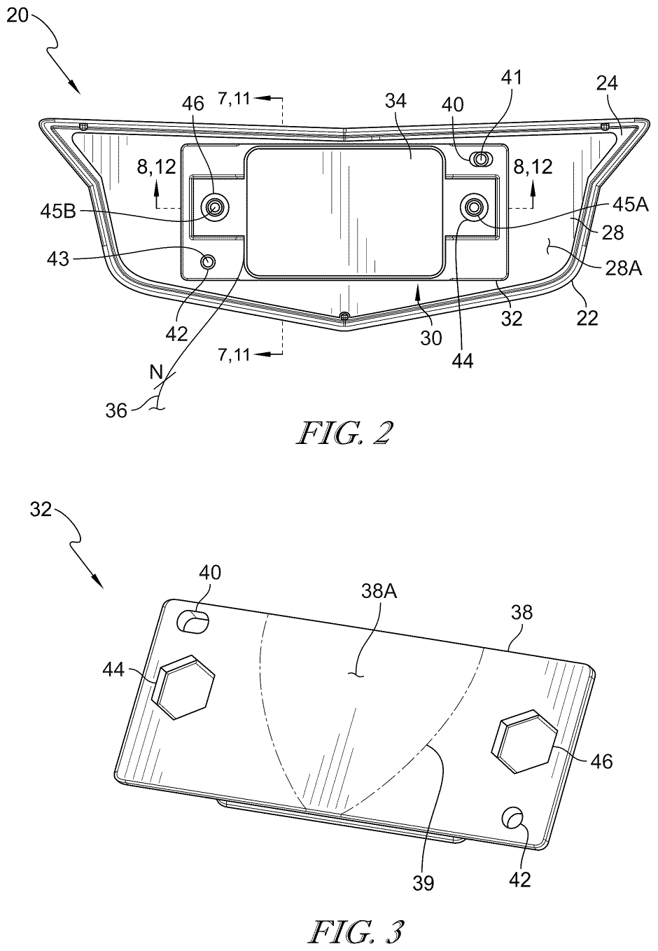

Referring now to FIG. 1, an example motor vehicle 10 is shown including a conventional operator side door 12, a conventional passenger side door 14 and a conventional rear hatch door or “liftgate” 16 hingedly coupled to the vehicle 10 at or near a roof 18 of the motor vehicle 10. In the illustrated embodiment, a sensor-based badge assembly 20 is illustratively mounted to the outer surface of the rear hatch door 16, and is operable, as briefly described above and as will be described in detail below, to change a state of the rear hatch door 16 by applying a force to the display surface 26 of the badge 22 of the badge assembly 20, i.e., by pressing the display surface 26 of the badge 22 with a body part or with an object. It will be understood that whereas the badge assembly 20 is depicted as being mounted approximately centrally on and to the rear hatch door 16, this depiction is provided only by way of example. In some alternate embodiments, the badge assembly 20 may be mounted elsewhere on or adjacent to the door 16. Alternatively or additionally, the badge assembly 20 or another badge assembly 20 may be mounted to, or adjacent to, the door 12 and/or the door 14. Generally, it will be understood that the badge assembly 20 illustrated in FIGS. 2-12 and described below may be mounted to, or adjacent to, any access closure of any motor vehicle.

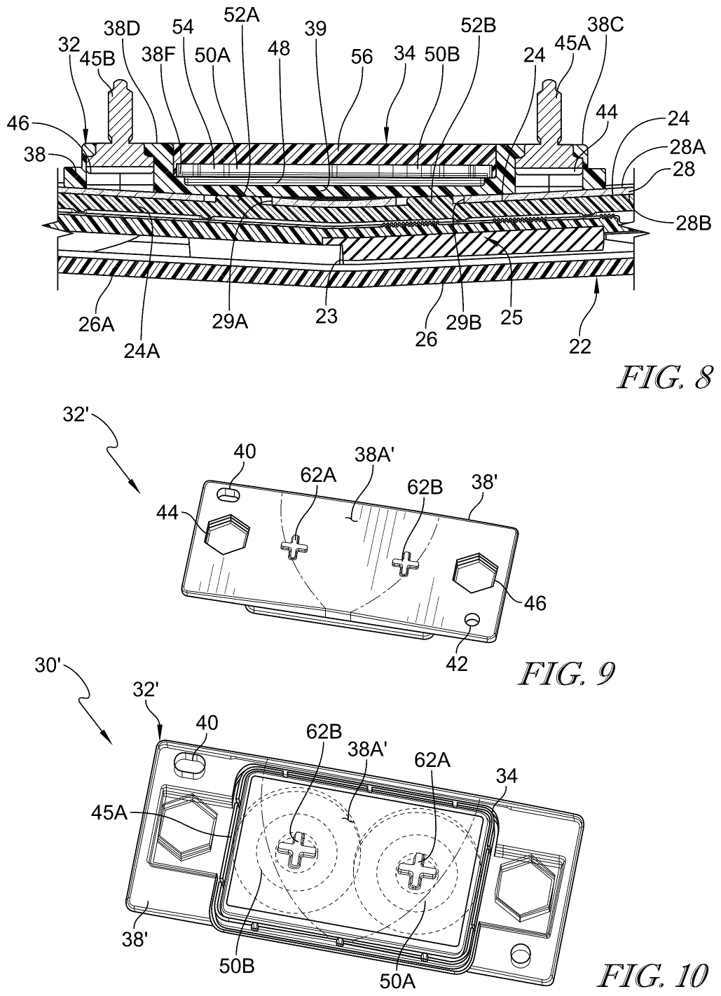

Referring now to FIGS. 2-8, an embodiment is shown of the badge assembly 20 depicted by example in FIG. 1. In the illustrated embodiment, the badge assembly 20 includes a motor vehicle badge 22, as defined above, including a mounting side, face or surface 24 and a display side, face or surface 26 opposite the mounting surface 24. In the illustrated embodiment, see, e.g., FIGS. 7 and 8, the mounting surface 24 is an external surface of a mounting plate or strip 24A, and the display surface 26 is an external surface of a display plate or strip 26A secured to the mounting plate in a conventional manner. In alternate embodiments, the mounting plate or strip and the display plate or strip may be of unitary construction. In either case, the illustrated badge 22 forms a gap or channel 23 between the mounting surface 24 and the display surface 26 within which one or more conventional badge components 25, e.g., layer(s), plate(s), strip(s) or other structure(s), is/are received. Illustratively, the mounting plate or strip 24A is formed of a rigid material of conventional composition, e.g., rigid plastic, metal or the like, such that the mounting surface 24 is a rigid mounting surface. In some embodiments, the display plate or strip 26A is likewise formed of a conventional rigid material, such that the display surface 26 is a rigid surface, although in alternate embodiments the display plate or strip 26A, or at least the display surface 26, may be at least partially flexible or semi-rigid. In some embodiments, the badge component(s) 25 is/are formed of conventional rigid material(s), although in alternate embodiments at least one badge component 25 may be at least partially flexible or semi-rigid. In any case, manual force applied to the display surface 26 generally in the direction of the gap or channel 23, e.g., by one or more fingers or hand or other body part of a person or by an object held or otherwise controlled by a person, is transferred by the display plate or strip 26 and badge component(s) 25 to the rigid mounting plate or strip 24A and thus to the rigid mounting surface 24 of the badge 20.

A sensor module 30 is operatively mounted to the mounting surface 24 of the motor vehicle badge 20 as illustrated by example in FIGS. 2, 7 and 8. In the illustrated embodiment, the sensor module 30 includes a housing 32 to which a sensor circuit 34 is operatively mounted as will be described in detail below. A conventional electrical cable 36 includes any number, N, of electrical wires, wherein N may be any positive integer, and one end of the electrical cable 36, i.e., respective ends of the N electrical wire(s), is/are electrically connected to the sensor circuit 34 in a conventional manner. An opposite end of the electrical cable 36, i.e., respective ends of the N electrical wire(s) is/are configured to be electrically connected to one or more controllers and/or one or more processor circuits of one or more control modules carried by the motor vehicle 10, wherein such one or more control modules is/are configured in a conventional manner to control one or more conventional actuators, e.g., one or more locks, latches, motors, etc., to change the state of the respective access closure of the motor vehicle.

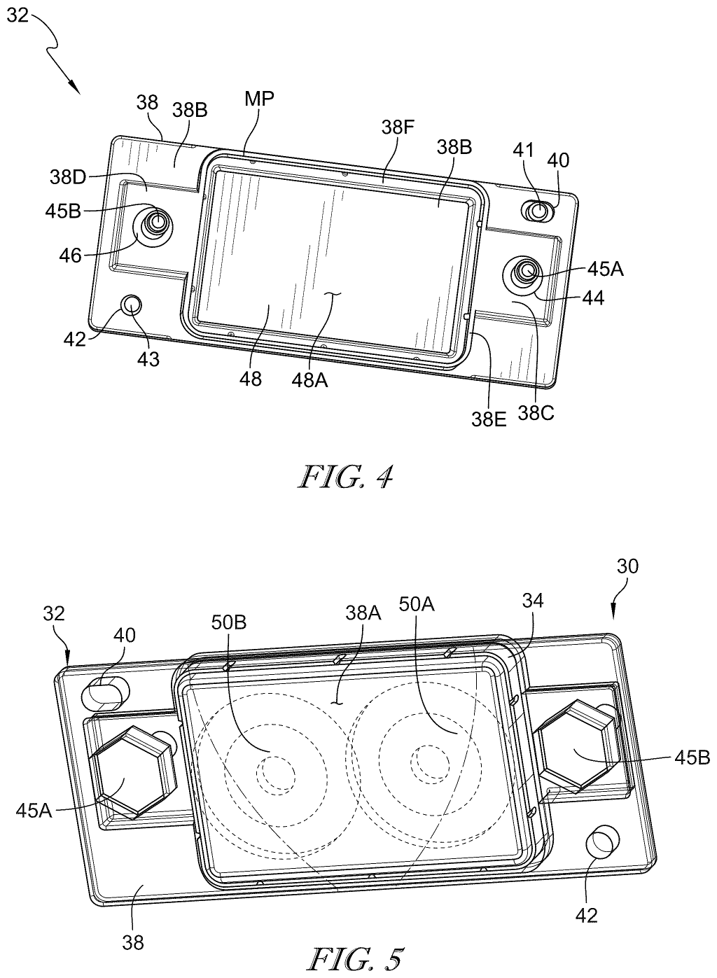

The housing 32 of the sensor module 30 illustratively includes a top or front plate or strip 38 defining a top or front surface 38A and a bottom or rear surface 38B opposite the top or front surface 38A. The top or front plate or strip 38 is illustratively formed of a conventional material, e.g., plastic or the like, having least a wall portion 39 thereof that is deflectable, e.g., flexible, plastically deformable, etc., in a direction generally normal to the rear surface 38B of the top or front plate 38. In some alternate embodiments more or less of the top or front plate or strip 38 than that shown by example in FIGS. 3 and 5 may form the deflectable wall portion 39, and in other alternate embodiments two or more separate portions of the top or front plate or strip 38 may be made to be deflectable. In any embodiment, the deflectable wall portion(s) 39 of the top or front plate or strip 38 is/are illustratively located on the plate or strip 38 so as to be aligned with, e.g., centered over, one or more inductive sensors carried by the sensor circuitry 34. In the illustrated embodiment, as will be described in greater detail below, the sensor circuit 34 illustratively includes two inductive sensors 50A, 50B laterally spaced apart from one another, e.g., side-by-side, and in this embodiment the single deflectable wall 39 of the top or front plate or strip 38 extends at least partially over both sensors 50A, 50B, including the centers of the sensors 50A, 50B as illustrated by example in FIG. 5.

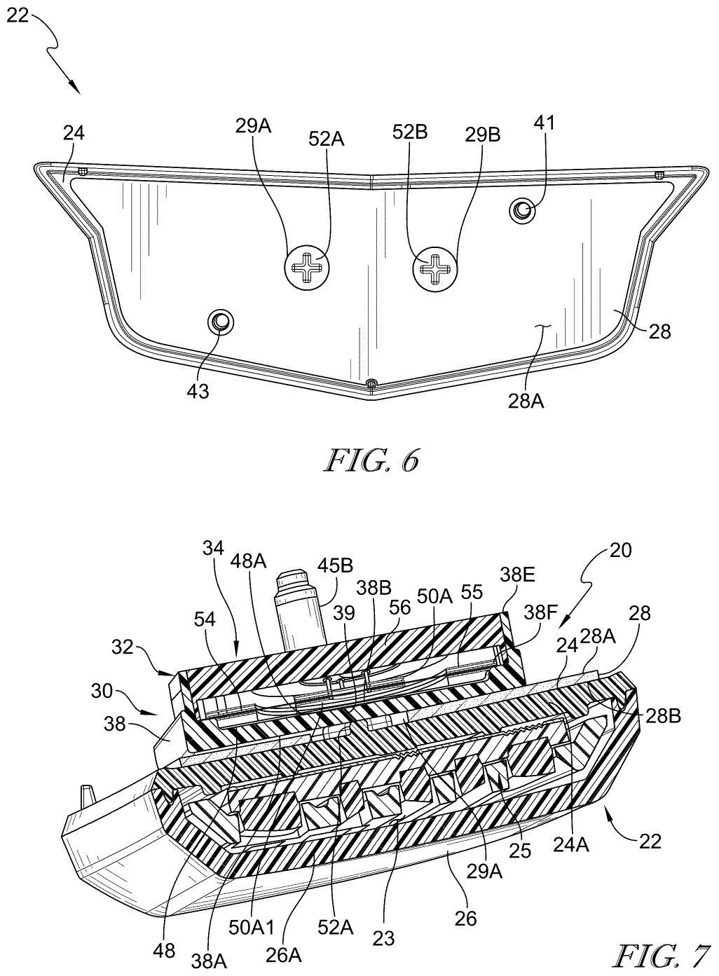

The mounting surface 26 of the mounting plate or strip 26A of the badge 22 is illustratively mounted via a bonding medium 28 to the top or front surface 38A of the top or front plate or strip 38. In one embodiment, the bonding medium 28 is provided in the form of a conventional double-sided, adhesive-backed foam tape having one major surface 28A affixed and bonded to the top or front surface 38A of the top or front plate or strip 38 and an opposite major surface 28B affixed and bonded to the mounting surface 24 of the badge 22, as depicted by example in FIGS. 2, 7 and 8. Illustratively, the compliance of the foam tape 28 allows the mounting surface 24 of the badge 22 to move, relative to the sensor module 30, in response to manual force, e.g., user press, applied to the display surface 26 of the badge 22, thereby facilitating deflection of the deflectable wall 39 of the top or front plate or strip 38 of the sensor housing 32 as described below. In alternate embodiments, the bonding medium 28 may be provided in other conventional forms including, for example, but not limited to, one or more time and/or temperature-curing bonding media, one or more adhesive pastes, gels or liquids, one or more formable bonding media, or the like. In some such embodiments, the formed bonding medium 28 may be compliant as described with respect to the foam tape embodiment. In the illustrated embodiment, locator openings 40 and 42 are defined through the top or front plate or strip 38, e.g., at or near opposite, diagonal corners (see, e.g., FIG. 3), and two respective locator pins 41 and 43 extend, e.g., normally, away from the mounting surface 24 of the badge 20 (see, e.g., FIG. 6), and the locator pins 41, 43 are received within the locator openings 40, 42 as the mounting surface 24 of the badge 22 is mounted to the top or front surface 38A of the top or front plate or strip 38 (see, e.g., FIGS. 2 and 4). The locator openings 40, 42 and the locator pins 41, 43 are illustratively positioned on and relative to the top plate 38 and mounting surface 24 respectively so as to align the sensor(s) carried by the sensor circuitry 34 with respective protrusion(s) extending away from the mounting surface 24 of the badge 22 as will be described in further detail below. In alternate embodiments, at least one of the locator openings 40, 42 may extend into the mounting surface 24 of the badge 22, and at least a corresponding one of the locator pins 41, 43 may extend from the top or front surface 38A of the top or front plate or strip 38.

The housing 32 of the sensor module 30 illustratively includes a mounting projection MP which extends generally perpendicularly away from the rear surface 38B of the top or front plate or strip 38, as best shown in FIG. 4. In the illustrated embodiment, the mounting projection MP and the top or front plate or strip 38 are of unitary construction, although in alternate embodiments the mounting projection MP may be separate from, and affixed in a conventional manner to, the top or front plate or strip 38. The mounting projection MP illustratively defines mounting wings 38C and 38D spaced laterally apart from one another by a pocket rim 38E. The pocket rim 38E and the portion of the rear surface 38B of the top or front plate or strip 38 surrounded by the pocket rim 38E together define a pocket 38F sized to receive the sensor circuit 34 therein. Mounting holes 44 and 46 are defined through the mounting wings 38C, 38D respectively, and conventional fixation elements 45A, 45B extend into and through the respective mounting holes 44, 46 for mounting the badge assembly 20 to the motor vehicle 10. The pocket rim 38E of the mounting projection MP is illustratively surrounds the deflectable wall portion 39 of the top or front plate or strip 38 such that the sensor circuitry pocket 38F is positioned opposite the deflectable wall 39. As best shown in FIGS. 4, 7 and 8, a conventional electrically conductive film 48 is positioned in the pocket 38F on or adjacent to the rear surface 38B of the top or front plate or strip 38 such that an exposed surface 48A faces the sensor circuitry 34 upon mounting of the sensor circuitry 34 in the pocket 38F. The electrically conductive film 48 is illustratively affixed to at least a portion of the rear surface 38B of the top or front plate or strip 38 in a conventional manner, e.g., via a conventional coating technique, via conventional adhesive or other bonding medium, or the like. In the illustrated embodiment, the electrically conductive film 48 covers the entire portion of the rear surface 38B of the top or front plate or strip 38 surrounded by the pocket rim 38E, as best shown in FIG. 4, although in alternate embodiments the electrically conductive film 48 may cover only portion(s) of the rear surface 38B of the top or front plate or strip 38 opposite respective sensor(s) included in the sensor circuitry 34. In some embodiments, the electrically conductive film 48 may be provided in the form of two or more electrically conductive films affixed to the rear surface 38B of the top or front plate or strip 38 or affixed to another structure configured to move toward the sensor circuitry 34 when contacted by the rear surface 38B of the top or front plate or strip 38. In any case, as the deflectable wall portion(s) 39 of the top or front plate or strip 38 is/are deflected toward the sensor circuitry 34, so too is/are the electrically conductive film(s) 48 affixed thereto.

The sensor circuitry 34 illustratively includes at least one inductive sensor, e.g., in the form of a conventional coil sensor. In the illustrated embodiment, which should be understood to be non-limiting and provided only by way of example, the sensor circuitry 34 includes two laterally-spaced apart coil sensors 50A, 50B, although in alternate embodiments more or fewer coil sensors may be included in the sensor circuitry 34. The sensor circuitry 34 further includes additional conventional circuitry 54, e.g., for providing electrical power and for processing signals produced by the coil sensor(s) 50A, 50B, and the coil sensor(s) 50A, 50B and the additional circuitry 54 are operatively mounted to a conventional circuit board 55 and electrically connected together in a conventional manner. Illustratively, the circuit board 55 (carrying the sensor(s) 50A, 50B and the additional circuitry 54) is secured in place within the pocket 38F of the housing 32 via a conventional potting compound 56, although in alternate embodiments the circuit board 55 may be secured within the pocket 38F of the housing 32 using other conventional circuit board attachment structure(s) and/or bonding medium(s) or the like.

In the embodiment illustrated in FIGS. 2-8, the mounting surface 24 of the rear plate or strip 24A of the badge 22 defines laterally spaced apart protrusions 52A, 52B extending therefrom, e.g., extending perpendicularly away therefrom. In the illustrated embodiment, the protrusions 52A, 52B are provided in the form of rigid, elongated pins or posts, each illustratively having “+” cross-sectional shapes as best shown in FIGS. 6-8. In alternate embodiments, the rear plate or strip 24A may be configured to include more or fewer such protrusions and/or with one or more protrusions having any cross-sectional shape without limitation. As also depicted in FIGS. 6-8, the bonding medium 28 defines openings 29A, 29B therethrough, wherein the openings 29A, 29B are positioned such that the protrusions 52A, 52B respectively extend therethough. When the mounting surface 24 of the mounting plate or strip 24A of the badge 22 is mounted to the top or front surface 38A of the top or front plate or strip 38 via the bonding medium 28 as described above, the protrusions 52A, 52B extend through the openings 29A, 29B of the bonding medium 28 between and in rigid contact with the mounting surface 24 of the mounting plate or strip 24A and the top or front surface 38A of the top or front plate or strip 38, whereas remaining portions of the mounting surface 24 of the mounting plate or strip 24A of the badge 22 and the top or front surface 38A of the top or front plate or strip 38 are separated from one another by the bonding medium 28, as best illustrated in FIGS. 7 and 8.

The protrusions 52A, 52B are illustratively located or positioned on the mounting surface of the mounting plate or strip 24A of the badge so as to align with, e.g., be centered over, the coil sensors 50A, 50B respectively. In this regard, the locator openings 40, 42 and the locator pins 41, 43 are illustratively positioned on and relative to the top plate 38 and mounting surface 24 respectively so as to guide the mounting of the badge 22 to the sensor module 30 in a manner which aligns, e.g., centers, the protrusions 52A, 52B over the coil sensors 50A, 50B respectively as the mounting surface 24 of the mounting plate or strip 24A of the badge 22 is mounted to the top or front surface 38A of the top or front plate or strip 38 via the bonding medium 28, as illustrated by example in FIGS. 7 and 8. Such alignment positions the rigid protrusions 52A, 52B in contact with and between the rigid mounting wall 24 of the badge 22 and the deflectable wall 39 of the top or front plate 38 of the sensor module 30, as also depicted by example in FIGS. 7 and 8. The protrusions 52A, 52B are thusly configured to transfer and concentrate force(s) applied to the display surface 26 of the badge 22 to the respective portions of the deflectable wall 39 of the top or front plate or strip 38 that extend over, e.g., centered over, the respective coil sensors 50A, 50B.

The coil sensors 50A, 50B are each illustratively configured in a conventional manner to produce a detectable change in the sensor signal respectively produced thereby in response to deflection of the respective the portion of the deflectable wall 39 of the top or front plate or strip 38 to cause the electrically conductive film 48 to move to within a detection proximity thereof. As illustrated most clearly in FIG. 7, for example, the sensor surface 50A1 of the coil sensor 50A is spaced apart from, and faces, the electrically conductive film 48 attached to the planar rear surface 38B of the top or front plate or strip 38 within the sensor module pocket 38F. The sensor 50B is likewise situated relative to the film 48. Deflection of the portion(s) of the deflectable wall 39 which extend over, e.g., centered over, the sensor(s) 50A, 50B in a direction toward the sensor(s) 50A, 50B, e.g., in response to manual force applied to the display surface 26 of the badge 22 as described above, thus causes the electrically conductive film 48 to be displaced toward the sensor(s) 50A, 50B. In some embodiments, the electrically conductive film 48 may be replaced by, or augmented with, one or more conventional electrically conductive member, so long as the one or more electrically conductive members is/are configured to move with the deflectable wall 39 toward and away from the sensors 50A, 50B. In some embodiments in which two or more sensors 50 are provided, the electrically conductive member(s), e.g., in the form of one or more electrically conductive films 48 and/or in the form of one or more other conventional electrically conductive members, may likewise be provided in the form of two or more separate electrically conductive members or films each positioned on the deflectable wall 39 over a respective one of the two or more sensors 50.

Operation of the inductive sensor(s) 50A, 50B is conventional in that the sensor coil(s) 50A, 50B is/are energized by the circuitry 54 on the circuit board 55 to create a sensor output signal in the form of an electromagnetic field adjacent to the sensor surface(s), e.g., 50A1, of the sensor(s) 50A, 50B. In one example embodiment, the circuitry 54 on the circuit board 55 includes at least one capacitive component electrically connected to the sensor coil(s) 50A, 50B such that the capacitive component(s) and the sensor coil(s) 50A, 50B together form resonant circuit(s). Time-varying signal(s) is/are applied to the resonant circuit(s) to produce time-varying electromagnetic field(s). The size(s) of the sensor coil(s) 50A, 50B and the strength(s) of the electromagnetic field(s) established by the energized sensor coil(s) 50A, 50B are selected such that the time-varying electromagnetic field(s) extend across the space between the sensor coil(s) 50A, 50B and respective portions of the electrically conductive film 48. When a respective portion of the deflectable wall 39 deflects inwardly a sufficient distance toward the respective sensor 50A, 50B, the electrically conductive film 48 is displaced to within a detection proximity of that sensor coil 50A, 50B. This results in a measurable loss in the resonant circuit which can be measured as a detectable change in the output signal of the respective sensor 50A, 50B. In one embodiment, this detectable change in the output signal of the respective sensor 50A, 50B is measured as a change in frequency over time, although in alternate embodiments the detectable change may be measured as a change over time in capacitance, inductance and/or resistance, e.g., relative to reference components onboard the circuit board 55.

The detectable change in the sensor signal(s) produced by the sensor(s) 50A, 50B illustratively causes a change of state of the respective access closure, as these terms are defined above. As described above, the electrical wire(s) carried by the electrical cable 36, is/are configured to be electrically connected to one or more controllers and/or one or more processor circuits of one or more control modules carried by the motor vehicle 10, wherein such one or more control modules is/are configured in a conventional manner to control one or more conventional actuators, e.g., one or more locks, latches, motors, etc., to change the state of the respective access closure of the motor vehicle. The detectable change in the sensor signal(s) produced by the sensor(s) 50A, 50B thus cause a change of state of the respective access closure via conventional operation of the one or more controllers and/or one or more processor circuits to control the one or more conventional actuators to physically change the state of the respective access closure in a conventional manner.

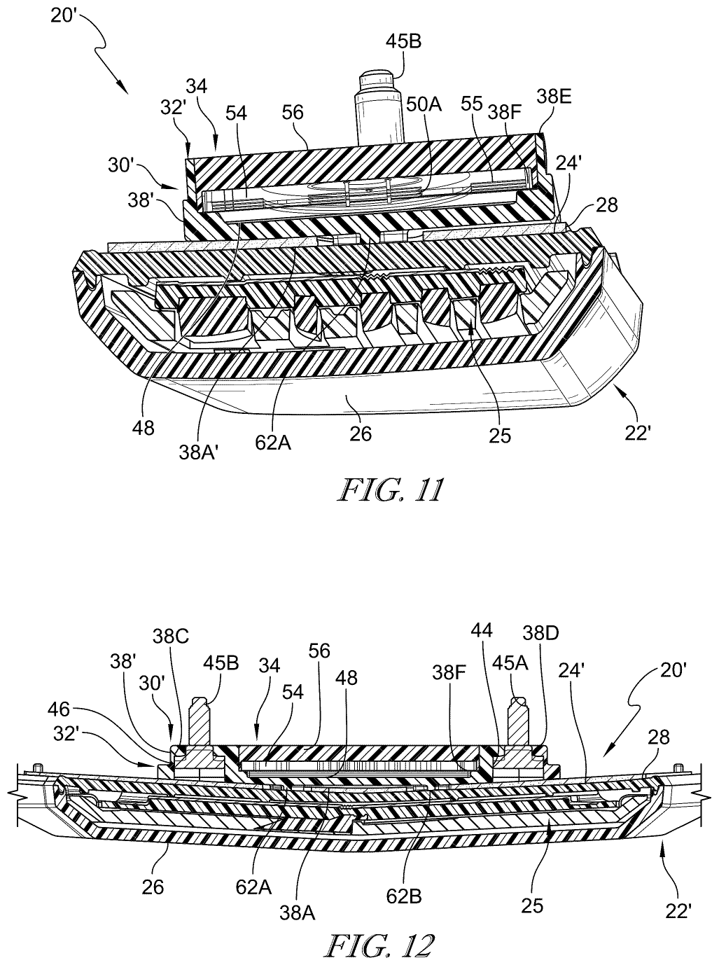

Referring now to FIGS. 9-12, an alternate embodiment is shown of a sensor-based badge assembly 20′. The sensor-based badge assembly 20′ is identical in many respects to the sensor-based badge assembly 20 illustrated in FIGS. 2-8 and described above, and like numbers are therefore used to identify like components. The sensor-based badge assembly 20′ differs from the sensor-based badge assembly 20 in that the mounting surface 24′ of the badge 22 does not include the protrusions 52A, 52B, and is instead illustratively planar as depicted by example in FIGS. 11 and 12, and further in that the top or front surface 38A′ of the top or front plate or strip 38′ of the housing 32′ includes two laterally spaced apart protrusions 62A, 62B extending, e.g., perpendicularly, therefrom. In this alternative embodiment, the protrusions 62A, 62B thus replace the protrusions 52A, 52B, and otherwise the structure and operation of the sensor-based badge assembly 20′ is identical to the sensor-based badge assembly 20 described in detail above. It will be understood that, like the sensor-based badge assembly 20, the sensor-based badge assembly 20′ may include more or fewer protrusions 62A, 62B.

It will be understood that whereas the example badge assembly 20, 20′ has/have been illustrated and described herein as including a single force concentrating protrusion 52A/52B, 62A/62B centered over each sensor 50A, 50B, alternate embodiments are contemplated in which any number of force concentrating protrusions may be used in combination with one or more sensors, wherein one or more of the protrusions may be centered over a respective sensor and/or one or more of the protrusions may not be centered over any sensor. In such alternate embodiments, one or a plurality of force concentrating protrusions may be arranged so as to be responsive to an external force applied, e.g., by a user, to the display surface 26 of the badge 22 to cause the deflectable wall 39 of the top or front plate or strip 38 to deflect sufficiently toward at least one of the one or more sensors so as to produce a detectable change in the sensor signal as described above. As another example, in the above description, the sensors 50A, 50B are described as being inductive sensors, e.g., conventional coil sensors. It will be understood that such sensor embodiments are provided only by way of example and that in alternate embodiments the sensor 50A and/or the sensor 50B, or a single such sensor in embodiments which include only one such sensor, or any one or more of multiple such sensors in embodiments which include more than two such sensors, may be provided in the form of any conventional sensor or sensor assembly configured to produce a detectable change in the sensor signal produced thereby in response to deflection of a corresponding portion of the deflectable wall 39 of the top or front plate or strip 38 to within a detection proximity of the sensor or sensor assembly.

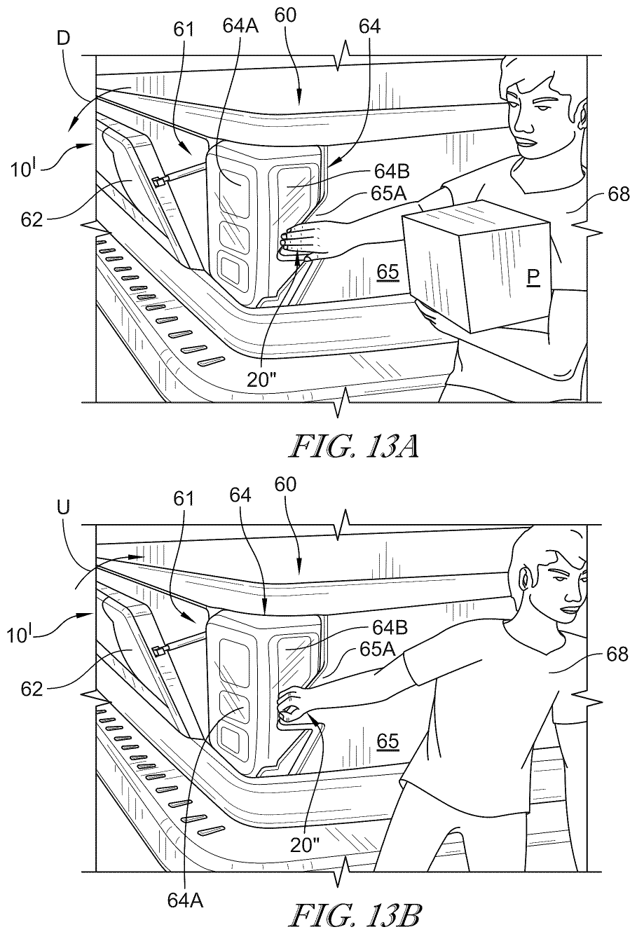

Referring now to FIGS. 13A and 13B, an embodiment is shown of a sensor-based closure control assembly 20″ illustratively mounted to a motor vehicle 10′, wherein sensor signals produced by the closure control assembly 20″, upon manual actuation of the closure control assembly 20″, are used by a control system to effect a change in at least the closed/open operating state of an access closure. The closure control assembly 20″ is illustratively identical to the badge assembly 20, 20′ as illustrated in FIGS. 1-12 and described above, except that in the closure control assembly 20″ the badge 22 is replaced with a cover 22″ having an exterior surface 26″ in place of the “display surface” 26 of the badge 22. It should be noted, however, as described hereinabove the exterior surface 26″ of the cover 22″ may or may not bear any information of the type described above with respect to the badge, and a “badge” may therefore be considered to be a subset of a “cover.” In this regard, the “cover” in any of the examples illustrated in FIGS. 13A-16 may, in some embodiments, have an exterior surface which does not bear any information of the type described above with respect to the badge and, in other embodiments, may be a “badge” as this term is defined and described above, i.e., as having an exterior surface which bears “badge” information of the type described above. In some embodiments of the former case, the exterior surface of the cover 22″ may not have any pattern formed thereon or therein, and may be a smooth, semi-smooth or roughened surface having a conventional finish, e.g., gloss, semi-gloss, satin, matte, or the like, and in other embodiments of the former case the exterior surface 22″ may have any pattern, e.g., repeating or non-repeating, formed therein or thereon, and may have any of the finishes just described. In any case, each closure control assembly depicted by example in any of the embodiments illustrated in FIGS. 13A-16 will be understood to be as described above with respect to the badge assembly 20, 20′ of FIGS. 2-12, except that the closure control assembly will be understood to include a “cover” which may or may not be a “badge” as just noted. All other aspects of each of the closure control assemblies of FIGS. 13A-16 will be understood to be as described above with respect to FIGS. 2-12.

In the embodiment illustrated in FIGS. 13A and 13B, the motor vehicle 10′ is depicted in the form of a conventional pickup truck having a rear cargo area 60 in the form of a so-called “bed” delineated by a front wall (not shown), spaced apart side walls 65 (only one shown), and an open rear portion 61 to which an access closure in the form of a tailgate 62 is operatively coupled. In the illustrated embodiment, the tailgate 62 is hinged along a bottom edge such that the tailgate 62 pivots, in a conventional manner, downwardly to open and expose the rear portion 61 and upwardly to close and cover the rear portion 61, i.e., such that the tailgate 62, in the closed state, forms a barrier across the open rear portion 61, and such that the tailgate 62, in the open state, does not form a barrier across the open rear portion 61 but instead allows for access to the cargo area or bed 60 via the open rear portion 61. Also in the illustrated embodiment, the tailgate 62 is illustratively a “power access closure,” as this term is defined above, such that the motor vehicle 10′ includes one or more motors and/or biasing structures or the like, configured to control the tailgate 62 from an open state to a closed state and/or from the closed state to the open state. The side walls 65 of the cargo area 60 are typically considered to be part of the body of the motor vehicle 10′, and the side walls 65 may therefore be referred to herein as “body panels.”

As is conventional with pickup trucks 10′, tail lamp assemblies 64 are mounted at least to the rear ends of the side walls 65 of the cargo area 60 (only one tail lamp shown in FIGS. 13A and 13B). In some embodiments, the tail lamp assemblies 64 are configured to be mounted only at the rear ends of the sides 65 of the cargo area 60 and to therefore illuminate rearwardly of the pickup truck 10′. In the embodiment illustrated in FIGS. 13A, 13B, in contrast, the tail light assemblies 64 are configured to mount to the rear ends of the side walls 65 and also to a portion of the side walls 65 adjacent to the rear ends thereof such that each tail light assembly 64 includes a rear section 64A which faces away from the rear of the cargo area 60, and a side section 64B which faces away from the respective side wall 65.

In the embodiment illustrated in FIGS. 13A and 13B, a portion 65A of the side wall or body panel 65 of the cargo area 60 of the pickup truck 10′ extends over a portion of the side section 64B of the tail light assembly 64, and in this embodiment the closure control assembly 20″ is mounted to the portion 65A of the side wall or body panel 65 such that the exterior surface of the cover of the closure control assembly 20″ (obscured in FIGS. 13A and 13B by the hand of the user 68) is exposed on the portion 65A. As depicted by example in FIG. 13A, the user 68 presses the exposed exterior surface of the cover of the closure control assembly 20″, i.e., with sufficient force to activate the sensor(s) as described above, to cause the power access closure 62, i.e., the power tailgate, to automatically, i.e., under control of the access closure control motor(s), etc., move from the closed state or position to the open state or position. As FIG. 13A demonstrates, pressing of the exposed exterior surface of the cover of the closure control assembly 20″ may be accomplished with one hand (alternatively by an elbow, arm, or other body part, or by an object held or otherwise carried by the user 68) so that the tailgate 62 may be opened by the user 68 whilst holding a package P or other object. As FIG. 13B demonstrates, the package P has been placed in the cargo area 60, and thereafter the user 68 again presses the exposed exterior surface of the cover of the closure control assembly 20″, i.e., with sufficient force to activate the sensor(s) as described above, to cause the power access closure 62, i.e., the power tailgate, to automatically, i.e., under control of the access closure control motor(s), etc., move from the open state or position to the closed state or position. Although not specifically shown in FIGS. 13A and 13B, it will be understood that two such tail lamp assemblies 64 will be included on the motor vehicle 10′; one at each rear and side of the motor vehicle 10′. In some embodiments, a closure control assembly 20′″ may be mounted to only one of the two tail light assemblies, and in other embodiments a closure control assembly 20′″ may be mounted to each of the two tail light assemblies, wherein either of the closure control assemblies 20′″ may be manually actuated to control the open/close state of the access closure 62

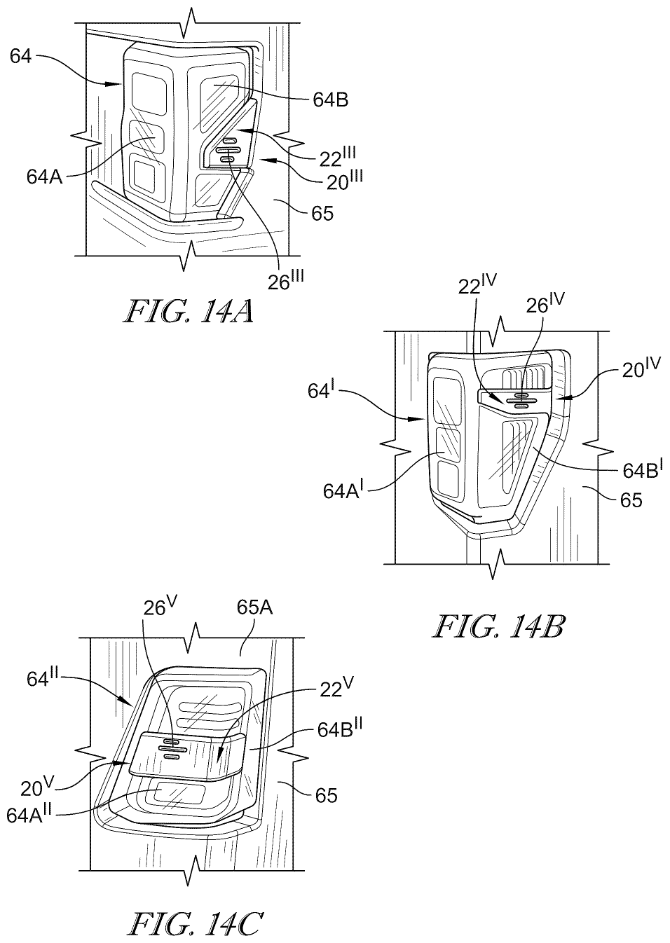

Referring now to FIG. 14A, an alternate embodiment is shown of a closure control assembly 20′″ illustratively mounted to the same type of motor vehicle 10′ as depicted in FIGS. 13A, and 13B, i.e., a pickup truck. In the embodiment illustrated in FIG. 14A, the closure control assembly 20′″ is mounted to, or integral with, the side section 64B of the tail lamp assembly 64 such that the exterior surface 26′″ of the cover 22′″ is exposed on and along a central portion of the side section 64B of the tail lamp assembly 64. In this embodiment, the exterior surface 26′″ of the cover 22′″ is illustratively painted the same color as that of the adjacent side wall or body panel 65, although in other embodiments the exterior surface 26′″ of the cover 22′″ may be painted other colors or be made translucent or transparent. Otherwise, the closure control assembly 20′″ is structurally and functionally identical to that described with respect to FIGS. 13A and 13B. Although not specifically shown in FIG. 14A, it will be understood that two such tail lamp assemblies 64 will be included on the motor vehicle 10′; one at each rear and side of the motor vehicle 10′. In some embodiments, a closure control assembly 20′″ may be mounted to only one of the two tail light assemblies, and in other embodiments a closure control assembly 20′″ may be mounted to each of the two tail light assemblies, wherein either of the closure control assemblies 20′″ may be manually actuated to control the open/close state of the access closure 62.

Referring now to FIG. 14B, another alternate embodiment is shown of a closure control assembly 20^{IV} illustratively mounted to the same type of motor vehicle 10′ as depicted in FIGS. 13A, and 13B, i.e., a pickup truck. In the illustrated embodiment, the tail lamp assembly 64′ includes a rear section 64A′ which faces away from the rear of the cargo area 60, and a side section 64B′ which faces away from the respective side wall 65. The closure control assembly 20^{IV} in the embodiment illustrated in FIG. 14B is mounted to, or integral with, the side section 64B′ of the tail lamp assembly 64′ such that the exterior surface 26^{IV} of the cover 22^{IV} is exposed on and along the side section 64B′ of the tail lamp assembly 64 near the top of the side section 64B′. In this embodiment, the exterior surface 26^{IV} of the cover 22^{IV} is illustratively painted the same color as that of the exterior trim components of the motor vehicle 10′, e.g., black, although in other embodiments the exterior surface 26^{IV} of the cover 22^{IV} may be painted other colors or be made translucent or transparent.

Otherwise, the closure control assembly 20^{IV} is structurally and functionally identical to that described with respect to FIGS. 13A and 13B. Although not specifically shown in FIG. 14B, it will be understood that two such tail lamp assemblies 64′ will be included on the motor vehicle 10′; one at each rear and side of the motor vehicle 10′. In some embodiments, a closure control assembly 20^{IV} may be mounted to only one of the two tail lamp assemblies, and in other embodiments a closure control assembly 20^{IV} may be mounted to each of the two tail lamp assemblies, wherein either of the closure control assemblies 20^{IV} may be manually actuated to control the open/close state of the access closure 62.

Referring now to FIG. 14C, another alternate embodiment is shown of a closure control assembly 20^{V} illustratively mounted to the same type of motor vehicle 10′ as depicted in FIGS. 13A, and 13B, i.e., a pickup truck. In the illustrated embodiment, the tail lamp assembly 64″ includes a rear section 64A″ which faces away from the rear of the cargo area 60, and a side section 64B″ which faces away from the respective side wall 65. The closure control assembly 20^{V} in the embodiment illustrated in FIG. 14C is mounted to, or integral with, the rear section 64A″ of the tail light assembly 64″ such that the exterior surface 26^{V} of the cover 22^{V} is exposed on and centrally along the side section 64B″ of the tail light assembly 64″, e.g., so as to bisect lighted portions above and below the cover 22^{V}. In this embodiment, the exterior surface 26^{V} of the cover 22^{V} is illustratively painted the same color as that of the exterior trim components of the motor vehicle 10′, e.g., black, although in other embodiments the exterior surface 26^{V} of the cover 22^{V} may be painted other colors or be made translucent or transparent. Otherwise, the closure control assembly 20^{V} is structurally and functionally identical to that described with respect to FIGS. 13A and 13B. Although not specifically shown in FIG. 14C, it will be understood that two such tail lamp assemblies 64″ will be included on the motor vehicle 10′; one at each rear and side of the motor vehicle 10′. In some embodiments, a closure control assembly 20^{V} may be mounted to only one of the two tail lamp assemblies, and in other embodiments a closure control assembly 20^{V} may be mounted to each of the two tail lamp assemblies, wherein either of the closure control assemblies 20^{V} may be manually actuated to control the open/close state of the access closure 62.

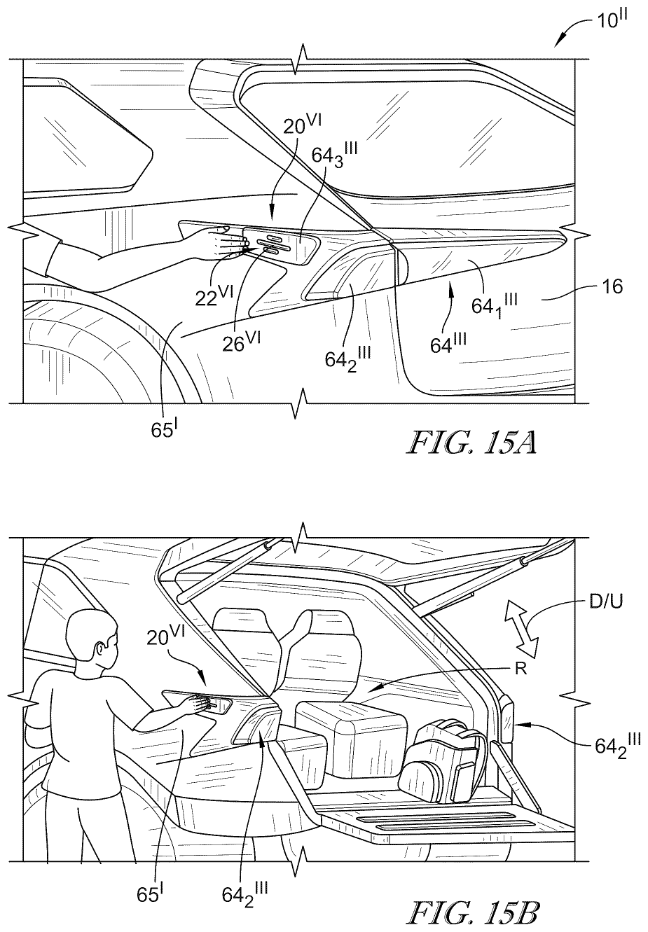

Referring now to FIGS. 15A and 15B, still another alternate embodiment is shown of a closure control assembly 20^{VI} illustratively mounted to another type of motor vehicle 10″, e.g., in this embodiment a sport utility vehicle or other motor vehicle having a power access closure in the form of a conventional power liftgate 16 operatively coupled to the motor vehicle 10″ to selectively cover and expose a rear access to a rear cargo area R as depicted in FIGS. 15A, and 15B. In the illustrated embodiment, each of two tail lamp assemblies 64′″ includes a section 64₁′″ mounted to the liftgate 16 at or near a respective side if the liftgate 16, and another section 64₂′″ mounted to a respective rearwardly-facing end of a rear body panel 65′ of the motor vehicle 10′″. In the illustrated embodiment, each section 64₂′″ of the respective tail lamp assembly 64′″ includes a frame, housing, or bracket 64₃′″ mounted to the rear body panel 65′ and extending along the side of the rear body panel 65′ as well as along an end portion of the rear body panel 65′. The section 64₂′″ of the tail lamp assembly 64′″ includes at least one light source mounted within the frame, housing, or bracket 64₃′″ and a lens assembly mounted to the frame, housing or bracket 64₃″′ with the at least one light source positioned between the lens assembly and the frame, housing, or bracket 64₃′″. The closure control assembly 20^{VI} in the embodiment illustrated in FIGS. 15A and 15B is mounted to, or integral with, the frame, housing, or bracket 64₃′″ of the section 64₂′″ of the tail lamp assembly 64′″ such that the exterior surface 26^{VI} of the cover 22^{VI} is exposed on and extends along the frame, housing, or bracket 64₃′″. In this embodiment, the exterior surface 26^{VI} of the cover 22^{VI} is illustratively painted the same color as that of the frame, housing, or bracket 64₃′″, e.g., black, although in other embodiments the exterior surface 26^{VI} of the cover 22^{VI} may be painted other colors or be made translucent or transparent. Otherwise, the closure control assembly 20^{VI} is structurally and functionally identical to that described with respect to FIGS. 13A and 13B. In some embodiments, a closure control assembly 20^{VI} may be mounted to only one of the two tail lamp assemblies, and in other embodiments a closure control assembly 20^{VI} may be mounted to each of the two tail lamp assemblies, wherein either of the closure control assemblies 20^{VI} may be manually actuated to control the open/close state of the access closure 16.

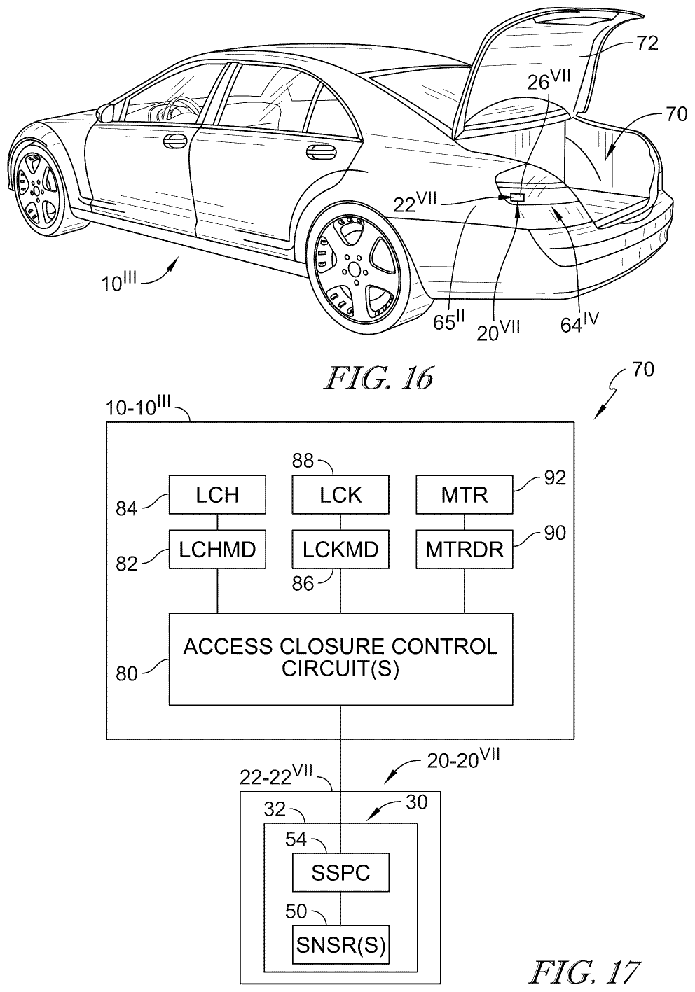

Referring now to FIG. 16, a further alternate embodiment is shown of a closure control assembly 20^{VII} illustratively mounted to another type of motor vehicle 10′″, e.g., in this embodiment a passenger car or other motor vehicle having a power access closure 72 in the form of a conventional power trunk (or conventional frunk located at a front end of the motor vehicle) operatively coupled to the motor vehicle 10′″ to selectively cover and expose an access to a rear (or front) cargo area 70 as depicted in FIG. 16. In the illustrated embodiment, each of two tail lamp assemblies 64^{IV} is conventional and is mounted to a respective rearwardly-facing end of a rear body panel 65″ of the motor vehicle 10′″. The closure control assembly 20^{VII} in the embodiment illustrated in FIG. 16 is mounted to, or integral with, the tail lamp assembly 64^{VII} such that the exterior surface 26^{VII} of the cover 22^{VII} is exposed on and extends along the tail lamp assembly 64^{VII}. In this embodiment, the exterior surface 26^{VII} of the cover 22^{VII} may be painted any color or be made translucent or transparent. Otherwise, the closure control assembly 20^{VII} is structurally and functionally identical to that described with respect to FIGS. 13A and 13B. In some embodiments, a closure control assembly 20^{VII} may be mounted to only one of the two tail lamp assemblies, and in other embodiments a closure control assembly 20^{VII} may be mounted to each of the two tail lamp assemblies, wherein either of the closure control assemblies 20^{VII} may be manually actuated to control the open/close state of the access closure 72.

It will be understood that the various closure control assemblies depicted in FIGS. 13A-16 may alternatively be mounted to, or integral with, another portion or component of the respective motor vehicle adjacent to or otherwise near the various depicted locations. Example alternative mounting or integral locations may include, but are not limited to, a portion of the body panel or bumper proximate to the tail lamp, an exterior surface of a portion of the respective access closure, a frame, housing, or bracket that is part of a tail light assembly or other assembly, or other external component of the motor vehicle.

Referring now to FIG. 17, an example control system 70 is shown for controlling an operating state of an access closure of a respective motor vehicle 10-10′″ based on sensor signals produced by a respective one of the closure control assemblies 20-20^{VII}. The control system 70 is illustratively located within the respective motor vehicle 10-10′″, although in some alternate embodiments at least some of the components of the control system 70 may be located in or on the respective closure control assemblies 20-20^{VII}, or in at least one vehicle-mounted (or mountable) module separate from the respective closure control assemblies 20-20^{VII}.

It will be understood that, depending upon the type and implementation of the power access closure, the control system 70 includes conventional access closure control circuit(s) 80 operatively coupled to one or any combination of an electronic latch module 82 operatively coupled to a respective electronically-controlled access closure latch 84, an electronic lock module 86 operatively coupled to a respective electronically controlled access closure lock 88, and at least one motor driver 90 operatively coupled to at least one motor for controlling the power access closure between open and closed positions and/or between closed and open positions. The control system 70 is illustratively operable, i.e., programmed, to be responsive to detectable changes in the sensor signal produced by the sensor(s) of a respective one or more of the closure control assemblies 20-20^{VII} to control one or more of the latch 84, lock 88, and motor(s) 92 to change a state of respective access closure, wherein the change of state of the respective access closure may be or include any one or combination of lock, unlock, latch, unlatch, open, or close, all as described hereinabove.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, whereas the various closure control assemblies 20-20^{VII} are illustrated by example in the attached figures and described herein as being positioned and configured to control a change of state of a power access closure located at the rear of the motor vehicle, e.g., truck tailgate, sport utility vehicle lift gate, automotive trunk, it will be understood that in alternate embodiments the closure control assembly may be located and configured to change a state of any power access closure of the motor vehicle including, for example, but not limited to, a power front trunk or “frunk” lid, a power side door, a power sliding door, or located and configured to change a state of a mechanically biased access closure, e.g., a biased access closure positioned over a fuel filling inlet, or the like.

What is claimed is:

1. A closure control assembly for controlling an operating state of an access closure of a motor vehicle, the closure control assembly comprising:
a sensor module configured to mount to the access closure or to an exterior component of the motor vehicle, the sensor module including a deflectable wall with opposing front and rear surfaces, at least one electrically conductive member affixed to or integral with the rear surface, and a sensor circuit including a sensor spaced apart from the at least one electrically conductive member and configured to produce a sensor signal,
a cover mounted to the sensor module with an interior surface of the cover facing the front surface of the deflectable wall of the sensor module, and with an exterior surface of the cover exposed on the access closure or on the exterior component of the motor vehicle to provide for manual contact therewith, and
at least one protrusion extending between the interior surface of the cover and the front surface of the deflectable wall, the at least one protrusion configured to concentrate force, applied by manual contact with the exterior surface of the cover, to the deflectable wall of the sensor module to cause the deflectable wall to deflect toward the sensor, the sensor configured to produce a detectable change in the sensor signal, for causing a corresponding change in the operating state of the access closure, in response to deflection of the deflectable wall sufficiently to move the at least one electrically conductive member to within a detection proximity of the sensor.

2. The closure control assembly of claim 1, wherein the at least one protrusion is affixed to or integral with the interior surface of the cover, such that the at least one protrusion extends from the interior surface of the cover toward and into contact with the front surface of the deflectable wall of the sensor module.

3. The closure control assembly of claim 1, wherein the at least one protrusion is affixed to or integral with the front surface of the deflectable wall of the sensor module such that the at least one protrusion extends from the front surface of the deflectable wall toward and into contact with the interior surface of the cover.

4. The closure assembly of claim 1, wherein the at least one protrusion is centered over the at least one sensor.

5. The closure assembly of claim 1, wherein the sensor circuit includes a plurality of sensors positioned side by side and each spaced apart from the at least one electrically conductive member and configured to produce a respective sensor signal, and the detectable change in the sensor signal comprises a detectable change in at least one of the sensor signals produced by the plurality of sensors,
and wherein the at least one protrusion includes a plurality of protrusions each extending between the interior surface of the cover and the front surface of the deflectable wall, each of the plurality of protrusions centered over a respective one of the plurality of sensors.

6. The closure control assembly of claim 1, wherein the sensor module is configured to be mounted to, or integral with, the exterior component of the motor vehicle with the exterior surface of the cover exposed on the exterior component,
and wherein the exterior component of the motor vehicle is adjacent to or near the access closure.

7. The closure control assembly of claim 6, wherein the exterior component of the motor vehicle to which the sensor module is configured to be mounted or integral with is a lamp assembly of the motor vehicle, a body panel of the motor vehicle, or a bumper of the motor vehicle.

8. The closure control assembly of claim 7, wherein the closure control assembly is configured to be mounted to, or integral with, the lamp assembly of the motor vehicle,
and wherein the lamp assembly comprises a frame, bracket, or housing configured to be mounted to the motor vehicle, at least one light source, and a lens assembly, including at least one lens, configured to be mounted to the frame, bracket, or housing with the at least one light source positioned between the lens assembly and the frame, bracket, or housing,
and wherein the closure control assembly is configured to be mounted to, or integral with, the frame, bracket, or housing such that the exterior surface of the cover of the closure control assembly is exposed along the frame, bracket, or housing, or is configured to be mounted to, or integral with, the lens assembly such that the exterior surface of the cover of the closure control assembly is exposed along the at least one lens.

9. The closure control assembly of claim 1, further comprising at least one processing circuit configured to be responsive to the detectable change in the sensor signal to produce at least one control signal configured to cause the corresponding change in the operating state of the access closure.

10. The closure control assembly of claim 9, wherein the access closure of the motor vehicle is a power access closure,
and wherein the closure control assembly further comprises means responsive to at least one control signal to change the operating state of the power access closure.

11. The closure control assembly of claim 10, wherein the power access closure is a trunk, a frunk, a tailgate, a liftgate, or a side door of the motor vehicle.

12. The closure control assembly of claim 10, wherein the closure control assembly is configured to be mounted to, or integral with, the exterior component of the motor vehicle with the exterior surface of the cover exposed on the exterior component.

13. The closure control assembly of claim 12, wherein the exterior component of the motor vehicle to which the closure control assembly is configured to be mounted or integral with is a lamp assembly of the motor vehicle, a body panel of the motor vehicle, or a rear bumper of the motor vehicle.

14. A system for controlling an operating state of a power tailgate of a motor vehicle, the system comprising:
the closure control assembly of claim 1, wherein the access closure is the power tailgate, and
at least one processing circuit configured to be responsive to the detectable change in the sensor signal to produce at least one control signal configured to cause the corresponding change in the operating state of the power tailgate,
wherein the exterior component is a tail lamp assembly of the motor vehicle, and the sensor module of the closure control assembly is mounted to or proximate to the tail lamp assembly and the exterior surface of the cover is exposed on or proximate to the tail lamp assembly of the motor vehicle to provide for manual contact therewith.

15. The system of claim 14, further comprising means responsive to the at least one control signal to change the operating state of the power tailgate,
and wherein the change in the operating state of the power tailgate includes a change from an open state of the power tailgate to a closed state of the power tailgate or a change from the closed state of the power tailgate to the open state of the power tailgate.

16. The system of claim 14, wherein the closure control assembly is mounted to, or integral with, the tail lamp assembly.

17. The system of claim 16, wherein the tail lamp assembly comprises a frame, bracket, or housing configured to be mounted to the motor vehicle, at least one light source, and a lens assembly, including at least one lens, configured to be mounted to the frame, bracket, or housing with the at least one light source positioned between the lens assembly and the frame, bracket, or housing.

18. The system of claim 17, wherein the sensor module of the closure control assembly is mounted to, or integral with, the frame, bracket, or housing such that the exterior surface of the cover of the closure control assembly is exposed along the frame, bracket, or housing.

19. The system of claim 17, wherein the sensor module of the closure control assembly is mounted to, or integral with, the lens assembly such that the exterior surface of the cover of the closure control assembly is exposed along the at least one lens.

20. The system of claim 14, wherein the sensor module of the closure control assembly is mounted to, or integral with, a body panel of the motor vehicle proximate to the tail lamp assembly such that the exterior surface of the cover of the closure control assembly is exposed along the body panel.
